(19) United States
(12) Patent Application Publication
(10) Pub. No.: US 2015/0128540 A1
(43) Pub. Date: May 14, 2015

(54) GAS TURBINE FILTER AND METHODS OF ASSEMBLING SAME

(71) Applicant: BHA Altair, LLC, Franklin, TN (US)

(72) Inventors: William Keith Eyers, Alton (GB); Andrew James Smith, Poole (GB)

(73) Assignee: BHA Altair, LLC, Franklin, TN (US)

(21) Appl. No.: 14/077,902

(22) Filed: Nov. 12, 2013

(51) Int. Cl. B01D 46/02; B01D 46/00

(52) U.S. Cl. CPC B01D 46/023; B01D 46/0005; B01D 46/026
USPC 55/379; 29/428

(57) ABSTRACT

Systems and methods are provided for a filter system with an internal support structure. An embodiment of the filter system includes a header frame, a support structure having at least one arm, and a filter unit having at least one pocket. The support structure extends between the header frame and the filter unit. In addition, the support structure is coupled to the filter unit by inserting the at least one arm of the support structure into the at least one pocket of the filter unit.

### BACKGROUND

The subject matter disclosed herein relates generally to filter systems used in gas turbines, and more particularly, to filter systems that include a support structure.

Filter systems are commonly used to remove particulate matter entrained in the ambient air. At least some known filter systems used with gas turbines also protect against pollution, moisture, vibration, and/or pressure surges. One form of known filter system uses a bag filter that extends over, and is supported by, a support cage. The support cage prevents “collapse” of the bag filter as air flows through the bag filter. In normal use, air flows through the bag filter via a header frame and exits the bag filter via the bag filter's closed end. Occasionally, known filters are subjected to reverse filtering direction where air flow enters the bag filter through the closed end and exits through the header frame. At least some known bag filters are undesirably susceptible to collapse during reverse air flow.

To prevent bag filters from collapsing during use, at least some bag filters use a metal cage that is separate from the bag filter. The metal cage is coupled to the bag filter to provide additional structural support to the bag filter. However, if the metal cage is not sufficiently aligned with the bag filter, then the cage may skew when subjected to the air flow which may cause excessive fretting. Over time, excessive fretting may lead to premature failure of the filter media or distort the metal cage thereby necessitating frequent replacement, both of which may be costly.

### BRIEF DESCRIPTION

In one aspect, a filter assembly is provided. The filter includes a header frame including a first side and a second side opposite the first side. The filter also includes a filter unit coupled to the second side of the header frame and including a plurality of pockets that are substantially parallel to each other and extending away from the header frame. In addition, the filter includes at least one spacer that is inserted within each one of the plurality of pockets. Furthermore, the filter includes a support structure extending between the header frame and the filter unit. The support structure includes at least one arm coupled to, and extending away from, the header frame. The at least one arm extends into one or more of the plurality of pockets and engages one or more of the at least one spacer.

In another aspect, an alternative filter assembly is provided. The filter includes a header frame including a first side and a second side opposite the first side. The filter also includes a filter unit coupled to the second side of the header frame and including a plurality of pockets that are substantially parallel to each other and extending away from the header frame. In addition, the filter includes a support structure extending between the header frame and the filter unit. The support structure includes at least one arm coupled to, and extending away from, the header frame. The at least one arm extends into one or more of the plurality of pockets.

In yet another aspect, a method of assembling a filter assembly is provided. The method includes coupling a header frame to a support structure having at least one arm. The method also includes extending the at least one arm into a filter unit. The method further includes coupling the filter unit to the header frame.

### BRIEF DESCRIPTION OF THE DRAWINGS

FIG. 1 is a schematic illustration of an exemplary gas turbine engine system including an exemplary inlet filter house;

FIG. 2 is a schematic illustration of an exemplary filter system, including a support structure that may be used with the filter house shown in FIG. 1;

FIG. 3 is an exploded view of the filter system shown in FIG. 2;

FIGS. 4A and 4B are cross-sectional side views of the filter system shown in FIG. 2;

FIGS. 5A and 5B are detailed side views of the filter system shown in FIG. 2; and

FIG. 6 is a flow chart of an exemplary method that may be implemented to assemble the filter system shown in FIG. 2.

### DETAILED DESCRIPTION OF THE INVENTION

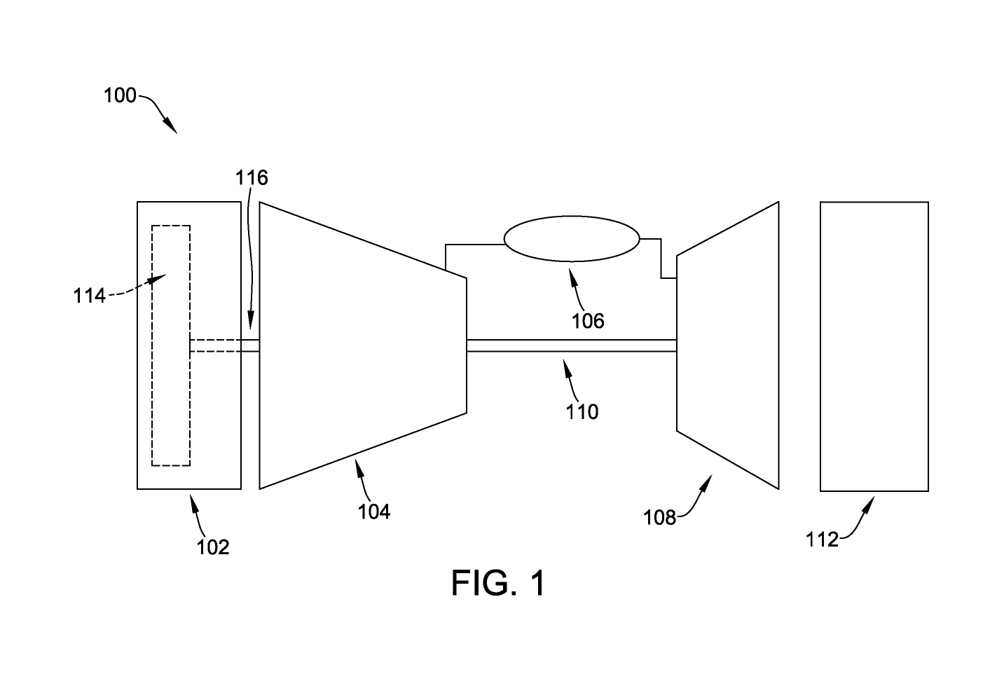

FIG. 1 is a schematic diagram of an exemplary gas turbine engine system 100. In the exemplary embodiment, gas turbine engine system 100 includes, coupled in serial flow arrangement, an inlet filter house 102 that includes a plurality of filter elements 114, a compressor 104, a combustor assembly 106, and a turbine 108 that is rotatably coupled to compressor 104 via a rotor shaft 110.

Gas turbine 100 may be used with a variety of filter classes of varying efficiencies. Filter classes include, but are not limited to, panel filters, bag filters, compact filters, pulse filters, and the like. Filters are also classified by efficiency, including, for example, medium efficiency filters, high efficiency filters, and very high efficiency filters. Embodiments of the present invention are intended for use with all filter classes and efficiency types applicable to gas turbines.

During operation, in the exemplary embodiment, ambient air flows into inlet filter house 102, wherein the ambient air is filtered. In the exemplary embodiment, the filtered air is channeled through an air inlet 116 towards compressor 104, wherein the filtered air is compressed prior to it being discharged towards combustor assembly 106. In the exemplary embodiment, the compressed air is mixed with fuel, and the resulting fuel-air mixture is ignited within combustor assembly 106 to generate combustion gases that flow towards turbine 108. In the exemplary embodiment, turbine 108 extracts rotational energy from the combustion gases and rotates rotor shaft 110 to drive compressor 104. Moreover, in the exemplary embodiment, the gas turbine engine system 100 drives a load 112, such as, for example, a generator, coupled to rotor shaft 110.

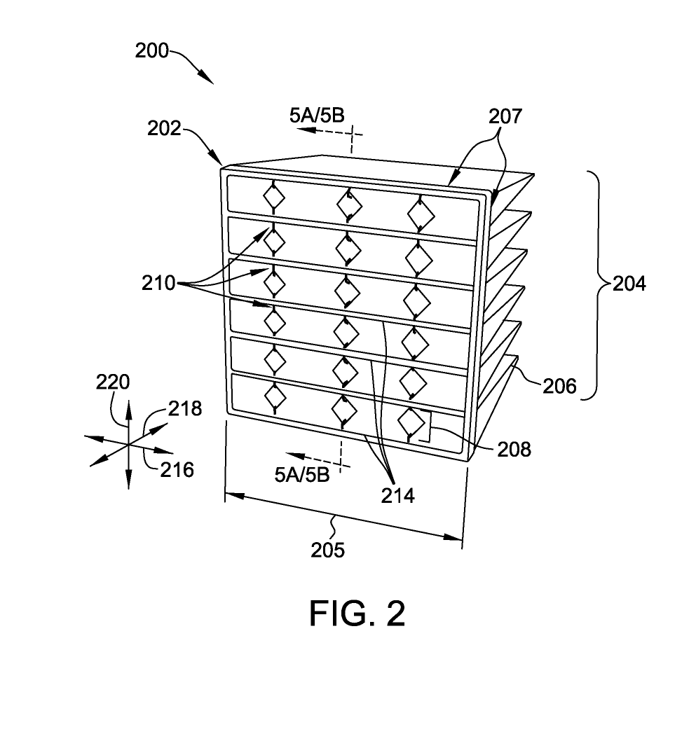

FIG. 2 is a schematic illustration of an exemplary filter system 200 with a support structure 210 (only shown partially in FIG. 2). In one embodiment, support structure 210 is formed from a stainless steel material. Alternatively, support structure 210 may be formed from plastic, wood, ceramic, composite, another type of metal, or any other material that enables support structure 210 to function as described herein. Filter system 200 also includes a header frame 202 and a filter unit 204. In the exemplary embodiment, header frame 202 circumscribes an entire outer perimeter 207 of filter unit 204 and includes a plurality of panes 214 where each pane 214 extends a full width 205 of filter unit 204 along its transverse axis 216.

In the exemplary embodiment, filter unit 204 is a bag filter. Alternatively, filter unit 204 may be a panel filter or a compact filter, for example. In the exemplary embodiment, filter unit 204 includes a plurality of pockets 206 that are arranged substantially parallel to each other along a vertical axis 220 of filter unit 204. In another embodiment, filter unit 204 may only include one pocket 206. In the exemplary embodiment, each pocket 206 is coupled to header frame 202 and substantially spans width 205 of filter unit 204 along its transverse axis 216. In addition, in the exemplary embodiment, each pocket 206 includes at least one spacer 208 inside. In a different embodiment, only some of pockets 206 may include spacers 208 while other pockets 206 remain empty. Alternatively, a different number of spacers 208 may be inserted into each pocket 206. In the exemplary embodiment, spacers 208 have a diamond-shaped cross-sectional profile. Alternatively, spacers 208 may have any cross-sectional shape, such as circular or square, that enables spacers 208 to function as described herein.

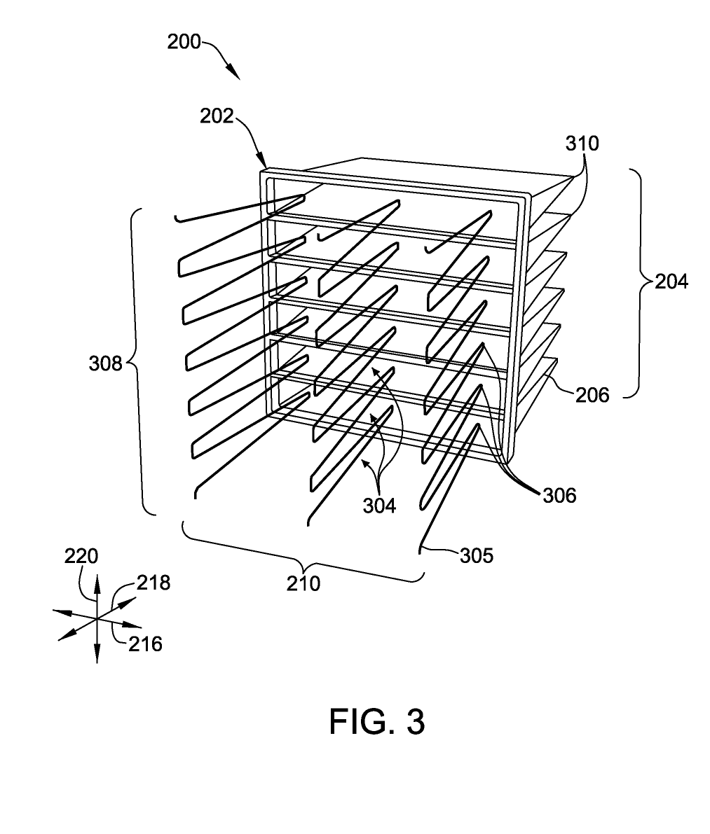

FIG. 3 is an exploded view of filter system 200. For clarity, support structure 210 is shown separated from filter unit 204 and includes columns 308 of arms 304. In the exemplary embodiment, there are three columns 308 of arms 304 that are arranged in parallel along a transverse axis 216 of filter unit 204. In one embodiment, support structure 210 is integrated into filter unit 204 via spacers 208 (not shown in FIG. 3). In the exemplary embodiment, filter system 200 is reversibly installable and may be installed in a reverse direction such that header frame 202 is downstream, rather than being installed in a normal orientation wherein header frame 202 would be upstream. For example, in a reverse orientation, air first enters filter system 200 via distal end 310 of filter unit 204 and flows the length of pockets 206 before exiting through header frame 202. In the reverse direction, a strong gust of air may induce enough pressure to cause pockets 206 to cave inwardly. However, support structure 210 prevents filter unit 204 from collapsing inwardly by forming an internal supporting structure within filter unit 204.

In the exemplary embodiment, arms 304 extend towards filter unit 204 and along the longitudinal axis 218 of filter unit 204. The exemplary embodiment shows arms 304 forming a plurality of columns 308 wherein each column 308 runs along the vertical axis 220 of unit filter 204. Alternatively, each column 308 of arms 304 may run along longitudinal axis 218 of filter unit 204, assuming that the orientation of pockets 206 are also appropriately transposed. Also in the exemplary embodiment, each arm 304 is inserted into a respective pocket 206 via a spacer 208 (not shown in FIG. 3). In another embodiment, for example, arms 304 may be bent metal rods in the shape of rectangular loops. Alternatively, arms 304 may be a triangular loop, an elliptical loop, an unbent tubular rod, or another shape that enables arms 304 to function as described herein. In the exemplary embodiment, each pocket 206 is sized to receive multiple arms 304 therein, however each spacer 208 is only sized to receive one arm 304. Alternatively, each spacer 208 may be sized to receive multiple arms 304. In one embodiment, proximal ends 305 of arms 304 are coupled to panes 214 of header frame 202. In addition, portions between proximal ends 305 and distal ends 306 of arms 304 may be coupled to the interior walls of pockets 206 via an adhesive or a mechanical fastening device. Alternatively, while proximal ends 305 of arms 304 are coupled to panes 214 of header frame 202 as well as to spacers 208, portions between proximal ends 305 and distal ends 306 of arms 304 are not coupled to anything.

Typically, without spacers 208, distal arm ends 306 of arms 304 will need to be connected to each other by some means, such as links, in order to achieve stability and to reduce rattling or fretting. Specifically, in operation, air flowing through filter system 200 may cause arms 304 to move about resulting in collision with each other or with the interior walls of pockets 206 thereby causing wear. Spacers 208 eschew the need for these connection means because spacers 208 function to facilitate alignment between arms 304 and pockets 206 and thereby prevent arms 304 from colliding with each other or the inside walls of filter unit 204. In an alternative embodiment, for example, pockets 206 do not include spacers 208 because arms 304 are sufficiently rigid or sufficiently spaced apart that movements of arms 304 do not affect each other or cause wear.

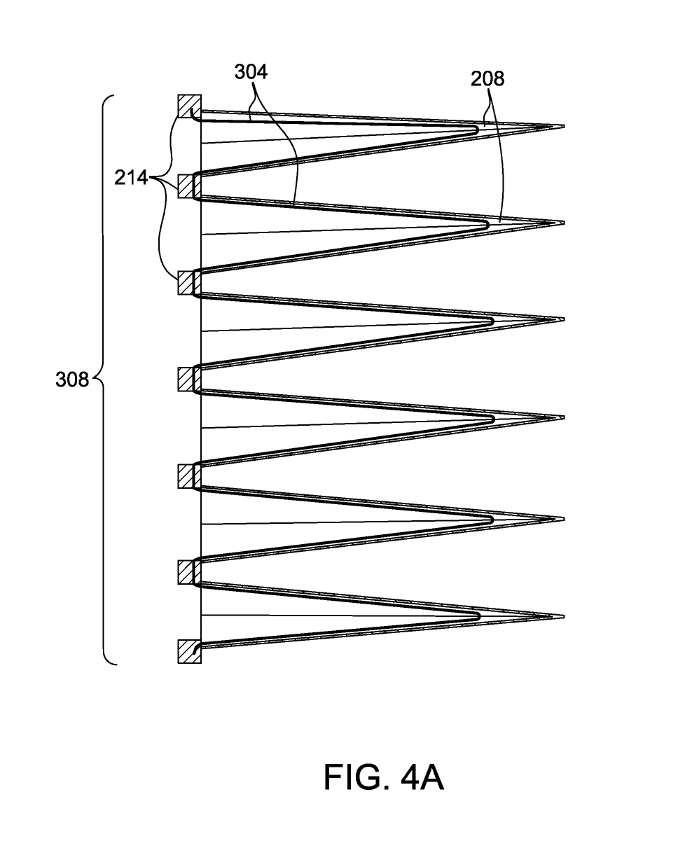

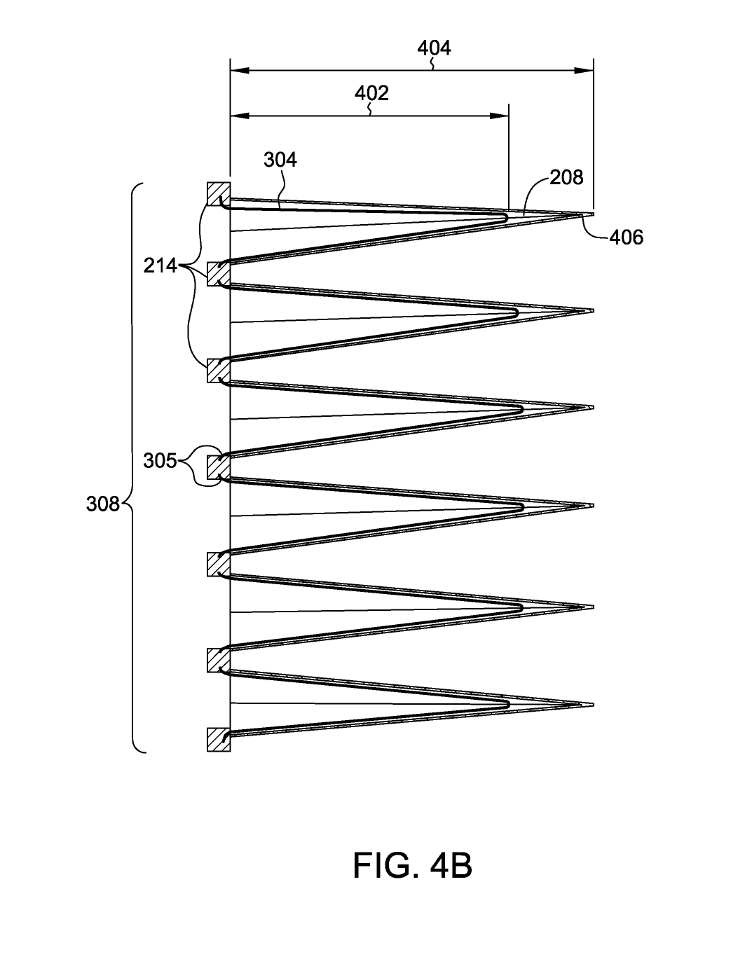

FIGS. 4A and 4B depict cross-sectional side views of filter system 200. A column 308 of arms 304 are extended into spacers 208. In the exemplary embodiment, column 308 has a plurality of arms that are formed from one continuous piece of material (as shown in FIG. 4A) that is looped through spacers 208 and through panes 214. Alternatively, arms 304 in column 308 may be formed from a plurality of pieces of material (as shown in FIG. 4B). In the exemplary embodiment shown in FIG. 4B, each arm 304 is formed from an individual piece of material that is coupled to the panes 214 at proximal end 305 of arm 304. In the exemplary embodiment, length 404 of pocket 208 exceeds length 402 of arm 304. Therefore, arm 304 is enclosed within pocket 208. Alternatively, length 402 of each arm 304 may exceed length 404 of pocket 208 and pocket 208 may have an opening at its distal end 406. Therefore, the excess length of arm 304 may be located outside of pocket 208 beyond distal end 406.

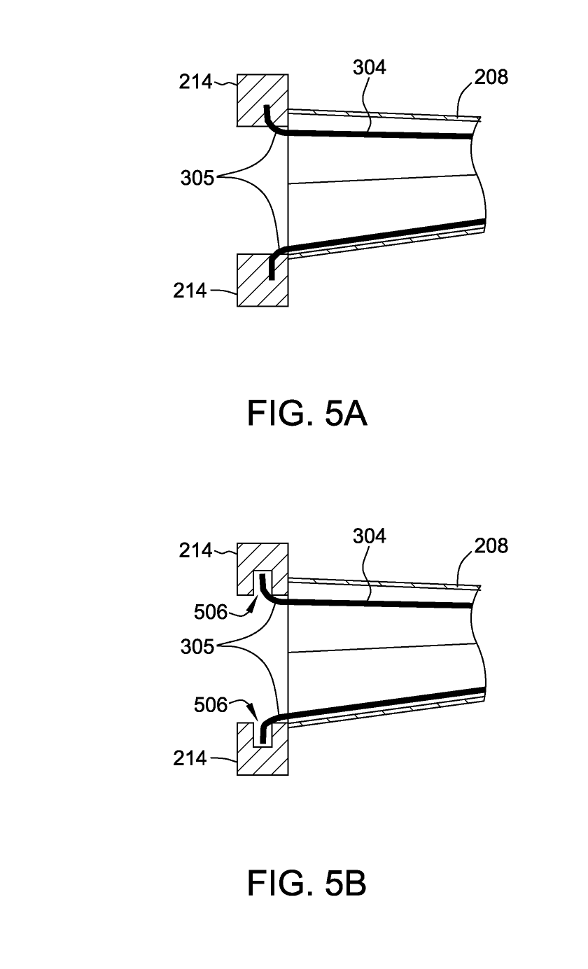

FIGS. 5A and 5B depict detailed side views of filter system 200. In FIGS. 5A and 5B, proximal arm ends 305 of arms 304 are coupled to panes 214 in header frame 202. In one embodiment panes 214 are formed from polyurethane. Alternatively, panes 214 may be formed from any other material, such as, for example, wood, metal, a different type of plastic, ceramic, and/or composite that enables panes 214 to function as described herein. In one exemplary embodiment (as shown in FIG. 5A), proximal arm ends 305 are molded into panes 214. Alternatively, proximal arm ends 305 may be coupled to panes 214 in a friction fit. In another exemplary embodiment (as shown in FIG. 5B), proximal arm ends 305 are removably coupled within recesses 506. Alternatively, any other coupling means may be used that enables proximal arm ends 305 to function as described herein. Coupling proximal arm ends 305 to and/or extending same from panes 214 facilitate aligning arms 304 with respect to spacers 208 and pockets 206 and maintaining arms 304 in the same orientation. As such, proximal arm ends 305 are less likely to shift position during operation and therefore arms 304 are less likely to rub against the inside walls of spacers 208 or pockets 206. As a result, there is less wear on arms 304, spacers 208, or pockets 206.

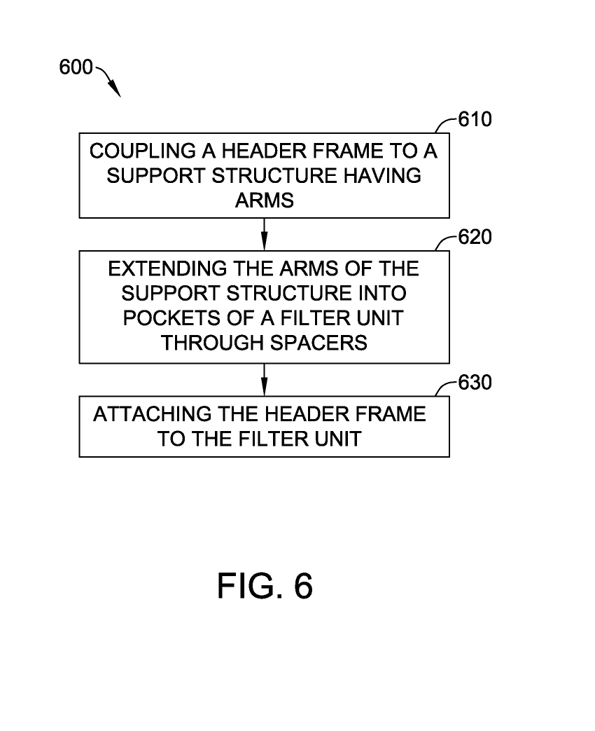

FIG. 6 illustrates a flow chart of an exemplary method 600 that may be implemented to assemble filter system 200. Initially a header frame, such as header frame 202 (as shown in FIG. 2) is coupled 610 to a support structure, such as support structure 210 (as shown in FIG. 3). The support structure may have one or more arms coupled in parallel to, and extending away from, the header frame. In one embodiment, for example, the proximal end of the support structure is held by the header frame in a friction fit. In another embodiment, the proximal end of the support structure snaps into a series of recesses disposed on the header frame, such as recess 506 (as shown in FIG. 5B). Alternatively, the proximal end of the support structure may be molded into the header frame while the distal end of the support structure remains unattached.

In one embodiment, the header frame is made of polyurethane. Alternatively, the header frame may be made of another type of material such as, for example, plastic, wood, ceramic, metal, and/or composite that enables the header frame to function as described herein. In one embodiment, the support structure is made of stainless steel. Alternatively, the support structure may be made of another material such as, for example, plastic, wood, ceramic, metal, and/or composite that enables the header frame to function as described herein.

Next, the arms of the support structure are extended 620 into a filter unit, such as filter unit 204 (as shown in FIG. 3). The filter unit may include pockets, such as pockets 206 (as shown in FIG. 3), arranged in parallel and extending away from the header frame. The pockets may further include spacers, such as spacers 208 (as shown in FIG. 2), disposed within the pockets. In one embodiment, the arms are extended 620 into the pockets through the spacers. In another embodiment, the arms are simply extended 620 into the pockets. In yet another embodiment, the arms are simply extended into a filter unit without pockets or spacers.

Then, the header frame is attached 630 to the filter unit. In one embodiment, for example, the entire outer perimeter of the proximal end of the filter unit is molded into one side of the header frame such that the header frame, support structure, and the filter unit form one entity thereby allowing all three components to function as an integral unit or a 1-piece unit. Alternatively, another order of assembly may be implemented such as, for example, coupling a support structure to a filter unit followed by coupling a header frame to the support structure. In another alternative embodiment, a header frame may be coupled to a filter unit followed by a support structure inserting into the filter unit and coupling to the header frame.

A filter system that includes a filter unit, a support structure, and a header frame that functions as an integral unit is disclosed herein. An internal support structure facilitates preventing an associated filter system from undesirably collapsing under air pressure when air flows through the filter systems in a reverse filtering direction. Coupling the internal support structure to the filter unit and the header frame result in improved alignment between the support structure and the filter unit. Improved alignment may reduce skewing or excessive fretting of the support structure against the filter unit. Furthermore, spacers disposed inside the filter units may provide rigidity to parts of the support structure thereby obviating the need for stabilizing linkage between those parts and resulting in decreased material cost.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

While the invention has been described in terms of various specific embodiments, those skilled in the art will recognize that the invention can be practiced with modification within the spirit and scope of the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A filter assembly comprising:
a header frame comprising a first side and a second side opposite said first side;
a filter unit coupled to said second side of said header frame and comprising a plurality of pockets that are substantially parallel to each other and extending away from said header frame;
at least one spacer is inserted within each one of said plurality of pockets; and
a support structure extending between said header frame and said filter unit, said support structure comprises at least one arm coupled to, and extending away from, said header frame, said at least one arm extends into one or more of said plurality of pockets and engages one or more of said at least one spacer.

2. The system in accordance with claim 1, wherein said at least one arm comprises a proximal end that is molded into said header frame.

3. The system in accordance with claim 1, wherein said at least one arm comprises a proximal end that is releasably attached to said header frame.

4. The system in accordance with claim 1, wherein said at least one arm comprises a plurality of arms wherein two or more arms are formed from a continuous piece of material.

5. The system in accordance with claim 1, wherein said filter unit is a bag filter installed in a reverse filtering direction.

6. The system in accordance with claim 1, wherein said at least one spacer comprises a cross-sectional profile of one or more of the following: diamond, square, and circle.

7. A filter assembly comprising:
a header frame comprising a first side and a second side opposite said first side;
a filter unit coupled to said second side of said header frame and comprising a plurality of pockets that are substantially parallel to each other and extending away from said header frame; and
a support structure extending between said header frame and said filter unit, said support structure comprises at least one arm coupled to, and extending away from, said header frame, said at least one arm extends into one or more of said plurality of pockets.

8. The system in accordance with claim 7, wherein said at least one arm comprises a proximal end that is molded into said header frame.

9. The system in accordance with claim 7, said at least one arm comprises a proximal end that is releasably attached to said header frame.

10. The system in accordance with claim 7, wherein said at least one arm comprises a plurality of arms wherein two or more arms are formed from a continuous piece of material.

11. The system in accordance with claim 7, further comprising at least one spacer inserted within each one of said plurality of pockets.

12. The system in accordance with claim 11, wherein said at least one arm extends into one or more of said plurality of pockets and engages one or more of said at least one spacer.

13. A method of assembling a filter assembly, said method comprising:
coupling a header frame to a support structure having at least one arm;
extending said at least one arm into a filter unit; and
attaching said filter unit to said header frame.

14. The system in accordance with claim 13, wherein extending said at least one arm into said filter unit further comprises inserting said at least one arm into at least one pocket disposed in said filter unit.

15. The system in accordance with claim 14, wherein inserting said at least one arm into said at least one pocket further comprises inserting said at least one arm into at least one spacer disposed within said at least one pocket.

16. The system in accordance with claim 13, wherein each of said at least one arm comprises a proximal end that is molded into said header frame.

17. The system in accordance with claim 13, wherein each of said at least one arm comprises a proximal end that is releasably attached to said header frame.

18. The system in accordance with claim 13, wherein said at least one arm comprises a plurality of arms wherein two or more arms are formed from a continuous piece of material.

19. The system in accordance with claim 13, wherein said filter unit is a bag filter installed in a reverse filtering direction.

20. The system in accordance with claim 15, wherein said at least one spacer comprises a cross-sectional profile of one or more of the following: diamond, square, and circle.
